(19) United States
(12) Patent Application Publication
(10) Pub. No.: US 2025/0298261 A1
(43) Pub. Date: Sep. 25, 2025

(54) BINOCULAR LOUPES

(71) Applicants: Kikuko YONEZAWA, Higashichikuma-gun, Nagano (JP); MEDSOLEIL CO., LTD., Higashichikuma-gun, Nagano (JP)

(72) Inventor: Kikuko YONEZAWA, Higashichikuma-gun, Nagano (JP)

(21) Appl. No.: 18/714,205

(22) PCT Filed: Jan. 27, 2023
(86) PCT No.: PCT/JP2023/002595

§ 371 Date: Oct. 21, 2024

(30) Foreign Application Priority Data
Feb. 4, 2022 (JP) 2022-016299

(51) Int. Cl. G02C 7/08

(52) U.S. Cl. CPC G02C 7/088; G02C 7/086; G02C 2200/02

(57) ABSTRACT

Provided are binocular loupes which enable loupe bodies including desired focus adjustment units and magnifications to be replaced, and which have bright clear image quality while further widening the field of view of a practitioner, the binocular loupes are provided with a pair of right-and-left loupe bodies 3 with internal optical systems, a glasses frame 10 for holding carrier lenses 4 to support the pair of loupe bodies 3 in visual directions toward an observation target, and cylindrical loupe holders 9 attached to the carrier lenses 4 to receive the loupe bodies attachably/detachably with eyepiece side ends of the pair of the loupe bodies 3 inserted, and the loupe holders 9 and eyepiece side members of the pair of loupe bodies 3 are formed of a plastic magnet molded by mixing magnetic powder into plastic materials.

### TECHNICAL FIELD

The present invention relates to binocular loupes used in medical operations and precision work operation.

### BACKGROUND ART

Binocular loupes have conventionally been used widely in various fields such as medical fields, precision work and jewel processing, as means for enlarging a local observation target on hand to visually identify. In these fields, high accuracy is required in operation of fine work on hand, and it is desired that the binocular loupes are provided with bright clear high image quality, in addition to excellent resolution, wide field of vision, focal distance and the like.

In addition thereto, in binocular loupes used in the medical field, the loupes are involved in human health and life, and therefore, are required to have functions such as proper vision correction and astigmatism correction by the binocular loupes in accordance with vision of the practitioner.

However, in conventional binocular loupes, regardless of high accuracy required in handwork of medical practitioners, with respect to vision cocreation to nearsightedness or farsightedness of the practitioner, and adjustments to focal distances of lenses, since it is not possible to adjust eyesight of the practitioner during the operation, while adapting to the type of the operation or situations changing during the operation, there is the problem that variations occur in accuracy of visual field and vision.

Further, regardless of that the vision of a human always varies corresponding to the extent of physical conditions and fatigue, and further varies in the morning and afternoon even on the same day, it is not possible to adapt the conventional binocular loupes to varying vision of the practitioner, and the practitioner has often performed operation work appropriately selecting binocular loupes in improper vision states to use.

Therefore, conventionally, binocular loupes have been known where a plurality of types of focus adjustment units with different focal distances is beforehand prepared, and one of the units is selected to enable the unit to be installed in an eyepiece unit thereof attachably/detachably (for example, see Patent Document 1).

FIG. 9 illustrates the type of binocular loupes described in Patent Document 1, and shows an example of first conventional technique where a loupe body is fixedly inserted into a carrier lens.

In FIG. 9, a loupe body 3 is provided with an internal enlargement optical system to adjust an image of an observation target under a predetermined magnification, for example, such as a two-time magnification and three-time magnification, and is comprised of an eyepiece barrel 2a positioned in an end on the eyepiece side, and a barrel 2c where an objective lens provided with a large-diameter portion is disposed via a tilting portion 2b for gradually increasing an outside diameter from the barrel 2a. Then, into a rear end of the eyepiece barrel 2a is inserted a magnetic ring 6 that sticks to a magnet. Herein, when the loupe body 3 is provided with an internal mechanism for enabling the lens to shift in a back-and-forth direction, it is possible to make focus adjustments.

On the eyepiece end side of the loupe body 3, a magnetic lens holding unit 12 is made along a circumference of a focus adjustment lens 11 so that the circular focus adjustment lens 11 is fitted. In order to correct the eyesight when a user of the binocular loupes enlarges and observes the target by right and left loupe bodies 3, this focus adjustment lens 11 is capable of being also made a lens to correct astigmatism and the like, not only to correct a far distance or a near distance used corresponding to the loupe body 3 as necessary.

Therefore, a focus adjustment ring (not shown) to adjust height of focus adjustment may be provided inside the focus adjustment lens 11. Further, even when a user of the binocular loupes does usually not need correction of the eyesight, adjustments to the eyesight are ensured, by using the focus adjustment lens 11 according to variations in the eyesight (nearsightedness or farsightedness) of the practitioner during treatment.

Thus, in the example of the conventional technique shown in FIG. 9 where the loupe body is fixedly inserted into the carrier lens, although the focus adjustment lens 11 is configured to be attachable and detachable with respect to the eyepiece unit end side of the loupe body 3, since the loupe body 3 is attached fixedly to the carrier lens 4, in the case of varying the magnification, it is necessary to replace the binocular loupes themselves including a glasses frame with other binocular loupes.

On the other hand, in the binocular loupes, since a required magnification varies corresponding to a part to treat, types of binocular loupes are also known where a plurality of kinds of binocular loupes is prepared, and as occasion demands, binocular loupes of an optimum magnification are selected to wear (for example, see Patent Document 2).

FIG. 10 illustrates the type of the binocular loupes described in, for example, Patent Document 2, and shows an example of second conventional technique of the type where a loupe body to use is selected as necessary from among a plurality of kinds of loupe bodies beforehand prepared and is inserted into the carrier lens attachably/detachably.

In FIG. 10, the example of second conventional technique is shown where a loupe holder 9 is attached to enable the loupe body 3 to be received in the carrier lens 4 attachably/detachably. As shown in the figure, it is configured that the loupe holder 9 is attached to the carrier lens 4 of the glasses frame 10, and that one loupe body 3 selected from among a plurality of kinds of loupe bodies beforehand prepared is attached to the loupe holder 9 attachably/detachably.

Then, in the conventional example shown in FIG. 10, the loupe body 3 is attached attachably/detachably to the loupe holder 9 fixed to the carrier lens 4, through a ring 6, and a magnet ring 5 provided with a plurality of concave portions 8 in a circumference of a side of the loupe body. Then, in this example, in view of easiness in manufacturing and so on, the magnet ring 5 is comprised of two semicircular rings 5a, 5b that couple to be one by magnetic properties, and is engaged in the loupe holder 9 via the ring 6.

On the other hand, in the circumference of the loupe body 3 on the eyepiece side, convex magnetic protrusions 7 are provided to engage in the concave portions 8 provided in the magnet ring 5, and the loupe body 3 is formed to be attracted to the magnet ring 5 so as to engage each other.

However, in the second conventional example, since the magnet ring 5 and magnetic ring 6 are connected to the eyepiece end side of the loupe body 3, the lens diameter of the binocular loupe on the eyepiece end side is needed to be a small diameter. As a result, the field of view (vision) of the binocular loupe is narrowed, thereby interfering with making the optical system of the binocular loupe brighter. Particularly, in order to reliably lock the loupe body 3 in the loupe holder by magnetic attraction forces, it is necessary to increase a volume (diameter×thickness) of each of the magnet ring 5 and magnetic ring 6.

In the second conventional example, as described above, a plurality of kinds of focus adjustment units with different focal distances is beforehand prepared to enable one to be selected from among the units and be inserted attachably/detachably. Further, in the conventional binocular loupes where a plurality of binocular loupes allowing the magnification to be adjusted is prepared to select optimal loupes as appropriate from among the loupes, since the structure of the binocular loupe body and the attachment unit (eyepiece unit) of the loupe holder for supporting the body is complicated, and parts of the attachable/detachable mechanism are high in number, the glass diameter of the ocular lens is thereby decreased, and as a result, the field of view (range of vision) of the practitioner is narrowed.

### PRIOR ART DOCUMENT

### Patent Document

Patent Document 1: Japanese Patent Gazette No. 5032332
Patent Document 2: Japanese Unexamined Patent Publication No. 2019-144297

### DISCLOSURE OF INVENTION

### Problems to be Solved by the Invention

The present invention was made in view of above-mentioned problems, and in binocular loupes enabling loupe bodies provided with internal optical systems for enlarging an observation target to visually identify, and focus adjustment units to be replaced easily with a desire magnification, it is an object of the invention to provide binocular loupes of bright and clear high image quality, while widening the field of view of a practitioner.

### Means for Solving the Problem

In order to solve the above-mentioned problem, the present invention is characterized in that binocular loupes for enlarging an observation target on hand to visually identify are provided with a pair of right-and-left loupe bodies with internal optical systems, a glasses frame for holding carrier lenses to support the pair of loupe bodies in visual directions toward the observation target, and cylindrical loupe holders attached to the carrier lenses to receive the loupe bodies attachably/detachably with the loupe bodies inserted from eyepiece sides of the pair of loupe bodies, the cylindrical loupe holders and contact surfaces coming into intimate contact states with cylindrical inner surfaces of the loupe holders and eyepiece end side surfaces in the loupe bodies are formed of plastic magnets molded by mixing magnetic powder into plastic materials, and that the loupe bodies come into intimate contact states with the cylindrical inner surfaces of the loupe holders to lock by magnetic attraction forces in the contact surfaces in the cylindrical inner surfaces and the eyepiece end side surfaces.

Thus, in the binocular loupes according to the present invention, the loupe holder and at least the contact surface of the loupe body coming into contact with the loupe holder are formed of plastic magnets molded by mixing magnetic powder into plastic materials, it is thereby possible to increase the diameter of the ocular lens at the eyepiece end of the loupe body, and thus, it is made possible to provide the binocular loupes of bright and clear high image quality, while widening the field of view of a practitioner.

Further, in the binocular loupes according to the present invention, in order to reliably lock the loupe body inside the loupe holder, the loupe body is inserted into the loupe holder further through a protrusion-provided ring having a protrusion portion, the loupe holder has an engagement portion of a hook-shaped groove to engage in the protrusion portion, and it is formed that the loupe body is not removed from the loupe holder. By this means, the thickness of the loupe holder in a cylindrical shape is allowed to be further thinner, corresponding thereto, it is possible to increase the glass diameter of the ocular lens, and as a result, it is made possible to provide the binocular loupe of bright and clear high image quality, while widening the field of view (range of vision) of a practitioner.

Herein, the protrusion-provided ring is formed of the plastic magnet molded by mixing magnetic powder into plastic materials, and enhances the attraction attachment force between the loupe body and the loupe holder.

Further, the invention is characterized in that at least each of the loupe holder and the loupe body is formed of anisotropic magnetized materials where crystal molecular arrangements of the magnetic powder are oriented in a certain direction, and that each of the loupe bodies is inserted into the loupe holder in a predetermined rotation direction.

Herein, the protrusion-provided ring is formed of anisotropic magnetized materials where the crystal molecular arrangement of the magnetic powder is oriented in the certain direction, and is aimed to more enhance a force for holding the loupe body in the loupe holder.

In addition, the loupe holder is fixed at a predetermined angle with respect to the surface of the loupe holder so that the inserted loupe body is directed toward the observation target. By this means, it is also possible to support astigmatism correction of a practitioner.

Then, in the loupe body in the binocular loupes, a plurality of types of bodies is beforehand prepared where magnifications by the optical system and/or vision adjustment distances differ from one another, one is selected from among the bodies and is attached to the loupe holder. Alternatively, the loupe body allowed to be selected and set within magnifications and/or vision adjustment distances in predetermined ranges may be selected and attached to the loupe holder.

Herein, a plurality of types of loupe bodies is beforehand prepared where magnifications by the optical system differ from one another, one is selected from among the bodies and is attached to the loupe holder, and one of a plurality of beforehand prepared vision distance adjustment lenses is fitted into the eyepiece side end of the loupe body attachably/detachably. In this case, the vision distance adjustment lens is held by a rim surrounding the circumference of the lens, and the rim is formed of a ferrite magnetic body.

### Effect of the Invention

According to the binocular loupes of the present invention, in the binocular loupes enabling loupe bodies with internal optical systems for enlarging an observation target to visually identify, and focus adjustment units to be easily replaced with a desired magnification, it is actualized to provide the binocular loupes provided with brighter clear image quality, while further widening the field of view of a practitioner, as compared with the binocular loupes of conventional techniques.

### BRIEF DESCRIPTION OF DRAWINGS

FIG. 1 shows an example of an entire outer view of binocular loupes of the present invention;

FIGS. 2A and 2B illustrate explanatory views in inserting one of loupe bodies constituting the binocular loupes into a loupe holder on the carrier lens side, where FIG. 2A illustrates an explanatory view in the case of inserting the loupe body directly into the loupe holder, and FIG. 2B illustrates an explanatory view in the case of inserting the loupe body into the loupe holder via a protrusion-provided ring;

FIGS. 3A-3C illustrate explanatory views in inserting one of the loupe bodies constituting the binocular loupes into the loupe holder on the carrier lens side in response to respective configurations of FIGS. 2A and 2B, where FIG. 3A illustrates an explanatory view in the case of inserting the loupe body directly into the loupe holder, FIG. 3B illustrates an explanatory view in the case of inserting the loupe body into the loupe holder via the protrusion-provided ring, and FIG. 3C shows an example where a window (notch) is provided to ensure the field of vision of a practitioner in the case that the practitioner identifies hands through the carrier lens;

FIG. 4 shows an example of the binocular loupes and loupe bodies with a plurality of magnifications and/or vision adjustment distances capable of being inserted into the carrier lens of the binocular loupes;

FIGS. 5A-5C show one example of a loupe body 3 in the binocular loupes, where FIG. 5A illustrates a side elevational view of the loupe body 3, FIG. 5B illustrates a front view of the loupe body 3 viewed from the objective lens side 3d side, and FIG. 5C illustrates a sectional view of the body 3;

FIG. 6 illustrates an explanatory view in a state in which a practitioner conducts work, while wearing the binocular loupes;

FIG. 7 illustrates an explanatory view of a downward insertion angle in attaching the loupes to the carrier lenses;

FIG. 8 illustrates an explanatory view about inward insertion angles p, q in attaching the loupe bodies to the carrier lenses;

FIG. 9 illustrates an explanatory view of conventional techniques, and shows an example of the first conventional technique where the loupe body is fixedly inserted into the carrier lens; and

FIG. 10 illustrates an explanatory view of conventional techniques, and shows an example of the second conventional technique where the loupe body is inserted attachably/detachably into the loupe holder on the carrier lens side.

### MODE FOR CARRYING OUT THE INVENTION

Embodiments of binocular loupes according to the present invention will be described below with reference to drawings.

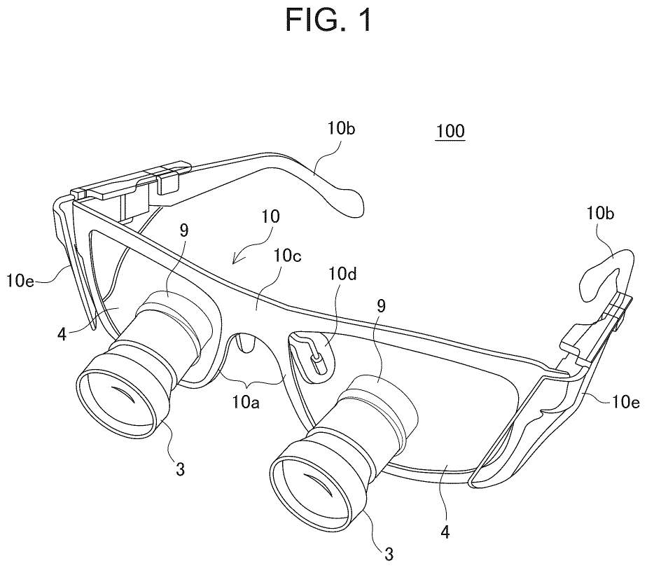

FIG. 1 illustrates an entire configuration of binocular loupes 100 according to one Embodiment of the present invention. The binocular loupes 100 are comprised of a glasses frame 10, loupe bodies 3 supporting right-and-left both eyes to enlarge an image of a work target, loupe holders 9 to hold the loupe bodies 3, and carrier lenses 4 that are loupe holders to attach the loupe holders 9 to the glasses frame 10.

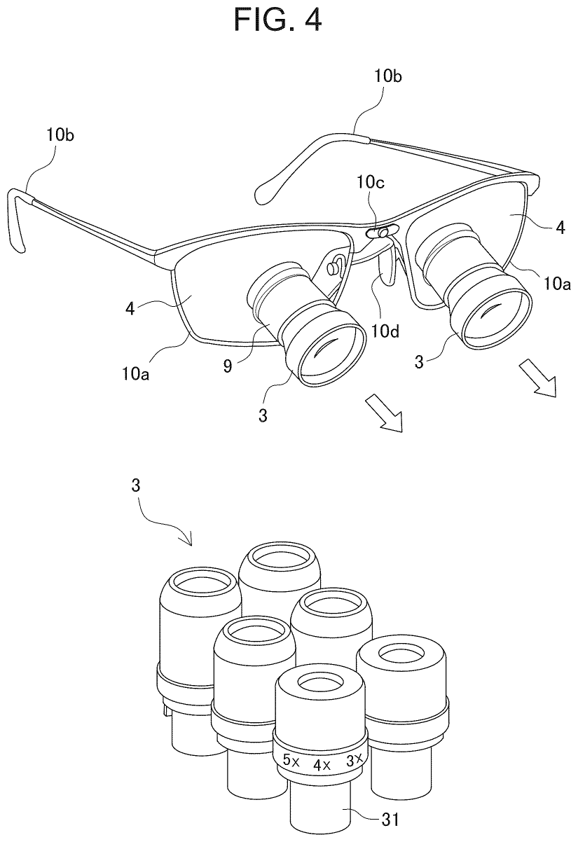

Herein, as shown in FIG. 4, there is a plurality of types of beforehand prepared loupe bodies 3 with different magnifications (e.g., three times, four times, five times) by optical systems and/or vision adjustment distances, and one of the bodies is selected and inserted into the loupe holder 9 attachably/detachably. In addition, as described later, with respect to vision adjustment functions, one of a plurality of beforehand prepared vision distance adjustment lenses may be fitted attachably/detachably into an eyepiece side end of the loupe body 3. By this means, it is possible to decrease the types (the number) of beforehand prepared loupe bodies 3.

In FIGS. 1 and 4, the glasses frame 10 has substantially the same structure as normal glasses, and includes rims 10a into which the carrier lenses 4 are fitted, a bridge 10c for joining temples 10b put on ears of an observer and the rims 10a, and nose pad portions 10d. As materials constituting the glasses frame 10 are used metal such as titanium hard to rust with flexibility, synthetic resins and the like. Then, when necessary, it is possible to attach, to the temples 10b, shield members 10e to protect both sides of a face of a wearer, and straps (not shown) to keep the binocular loupes in a worn state.

In the carrier lenses 4, openings are pierced to support the loupe holders 9 for holding the loupe bodies 3 at opposite ends thereof, and the loupe holders 9 are fitted into the openings, and are fixed in states of maintaining predetermined angles with respect to surfaces of the carrier lenses 4. As materials constituting the carrier lenses 4, although the materials are not needed to be always transparent, the materials are preferably transparent to widen the field of vision of an observer in a hand direction. Further, correction lenses may be used in the case of needing correction of vision, and in the case without the need for correcting vision, simple transparent glasses may be used. In this case, materials of the lenses are glass or plastic. Accordingly, together with the function of the loupe holders for supporting the loupe bodies, as necessary, the carrier lenses 4 are also provided with the function of correcting vision.

Further, in the loupe bodies 3 shown in FIG. 4, a loupe body shown by symbol 31 denotes a loupe body 31 enabling a practitioner to select a magnification of the lens and vision adjustment during treatment, and corresponding to the need during the treatment, the practitioner is capable of setting the magnification at three times (3×), four times (4×) or five times (5×), by rotating a barrel of the loupe body 3 on the objective lens side.

In addition, descriptions will be given later to details for fixing the loupe holder 9 in a state of maintaining the predetermined angle with respect to the surface of the carrier lens 4.

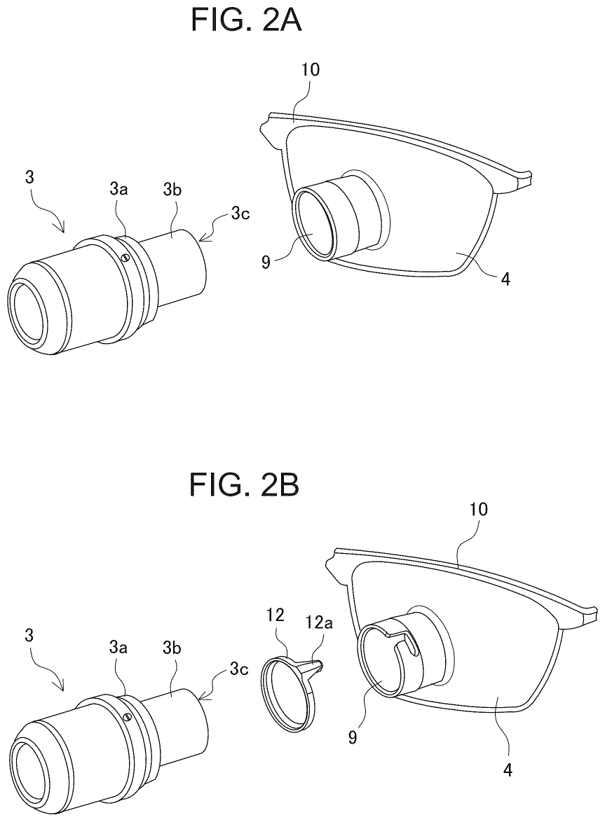

FIGS. 2A and 2B illustrate a state before the loupe body 3 is inserted into the loupe holder 9 fixed in the state of maintaining the predetermined angle with respect to the surface of the carrier lens 4, in the binocular loupes 100 according to the present invention shown in FIG. 1.

FIG. 2A illustrates the case where the loupe body 3 is directly inserted into the loupe holder 9, and then, FIG. 2B illustrates the case where the loupe body 3 is inserted into the loupe holder 9 with a protrusion-provided ring 12 nipped therebetween.

As shown in FIG. 2A, the loupe holder 9 is fixed to the carrier lens 4 at the predetermined angle, and the loupe body 3 is inserted into the loupe holder 9. In the loupe body 3, in a barrel body with a plurality of optical lenses stored are formed an intimate-contact surface 3b for contacting the inner surface of the cylindrical loupe holder 9 in an intimate-contact state, a contact surface 3a for hitting the cylindrical front end surface of the loupe holder 9 to come into contact therewith, and an eyepiece end side surface 3c of the loupe body 3.

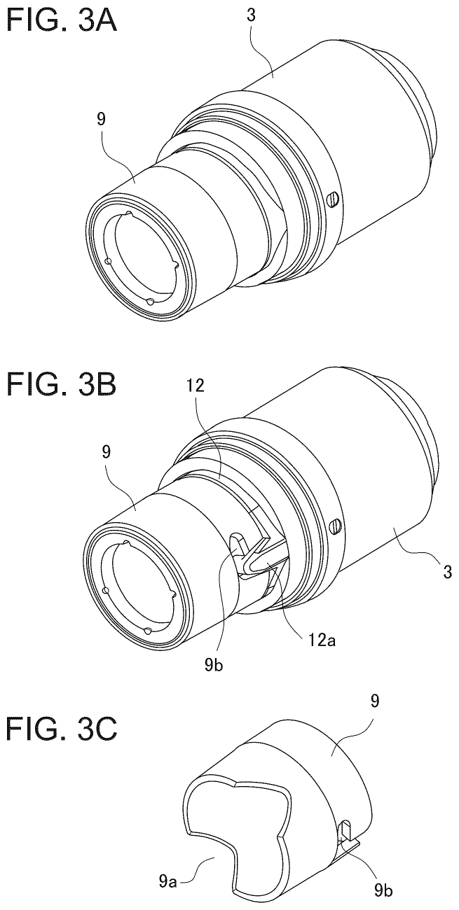

FIG. 2B illustrates the case where the loupe body 3 is inserted into the loupe holder 9 with the protrusion-provided ring 12 coming into intimate contact with the loupe body nipped therebetween. In this case, the loupe holder 9 includes an engagement portion 9b (see FIGS. 3A-3C) of a hook-shaped groove to engage in the protrusion portion 12a provided in the protrusion-provided ring 12, and by this means, for example, when a finger of the practitioner, lighting equipment of an operation room or the like contacts the loupe body 3, it is possible to prevent the loupe body 3 from being easily removed from the loupe holder 9.

In addition, the example shown in FIG. 2B illustrates the case where one protrusion portion 12a is provided in the protrusion-provided ring 12, and by providing a plurality of (for example, two or three) protrusion portions 12a, it is possible to more reinforce prevention of removal of the loupe body 3 from the loupe holder 9.

Further, in the example shown in FIG. 2A, as distinct from the example shown in FIG. 2B, the loupe body 3 is inserted directly into the loupe holder 9 attachably/detachably without passing through the protrusion-provided ring 12, and may be inserted into the loupe holder 9 attachably/detachably through a ring (not shown) without the protrusion portion 12a.

FIG. 3A illustrates a state in which the loupe body 3 shown in FIG. 2A is directly inserted into the loupe holder 9, and FIG. 3B illustrates a state in which the loupe body 3 shown in FIG. 2B is inserted into the loupe holder 9 with the protrusion-provided ring 12 nipped therebetween. As shown in FIG. 3B, the protrusion portion 12a of the protrusion-provided ring 12 engages in the engagement portion 9b of the hook-shaped groove provided on the loupe holder 9 side, and the loupe body 3 is thereby not easily removed from the loupe holder 9.

Herein, with respect to the loupe holder 9, the inner contact surface 3b with the cylindrical loupe holder 9 on the eyepiece end side of the loupe body 3, the contact surface 3b for hitting the cylindrical front end surface of the loupe holder 9 to come into contact therewith, and the eyepiece end side surface 3c of the loupe body 3, the holder 9 and the surfaces 3a, 3b, 3c are formed of plastic magnets molded by mixing magnetic powder into plastic materials. By this means, the loupe body 3 is not removed from the loupe holder 9.

In addition, as shown in FIG. 3C, in the loupe holder 9, in order that the thickness of the loupe holder 9 does not interfere with the visual field of the carrier lens 4 when the practitioner views the hands through the carrier lens 4, not through the loupe body 3, for example, a window (notch) to ensure visibility may be provided in right-and-left two portions in the visual direction and/or on the lower side in the visual direction.

Further, when the loupe body 3 is inserted into the loupe holder 9 via the protrusion-provided ring 12 having the protrusion portion, by also forming the protrusion-provided ring 12 using the plastic magnet molded by mixing the magnetic powder into plastic materials, the loupe body 3 is promoted to maintain insertion into the loupe holder 9 by stronger magnetic forces.

Herein, it is preferable that at least the loupe holder 9 and contact portions 3a, 3b, 3c with the loupe holder 9 in the loupe body 3 are formed of anisotropic magnetized materials where crystal molecular arrangements of the magnetic powder are oriented in a certain direction, and that the loupe body 3 is inserted into the loupe holder 9 in a predetermined rotation direction.

Further, in this case, by also forming the protrusion-provided ring 12 using the anisotropic magnetized materials where the crystal molecular arrangement of the magnetic powder is oriented in the certain direction, it is possible to more enhance the holding force of the loupe body in the loupe holder. As described above, it is possible to provide the protrusion portion 12a of the protrusion-provided ring 12 formed of the above-mentioned plastic magnet materials not only in a single portion, and also two portions or three portions.

Herein, the plastic magnet is molded by mixing magnetic powder into plastic, and it is possible to manufacture a magnetic plastic member in a desired shape using die sintering molding, press molding, injection molding, extrusion molding and the like. Further, by adding a small amount of rubber materials, it is also possible to manufacture members having elasticity.

With respect to strengths of magnetism, it is possible to manufacture magnetic compounds with various numeric values corresponding to magnetic materials to mix. For example, neodymium bonded materials (Nd—Fe—B) contain neodymium, iron and boron, are plastic magnets manufactured by combining and bonding resins thereto, enable press processing of thin shape and processing of complicated shape, are usually isotropy, and are capable of being magnetized in a diameter direction, height direction and multi-poles.

Thus, the plastic magnet is capable of being magnetized in a direction of magnetic field and strength of magnetic force in accordance with desires, and thereby enables the loupe holder 9 and the contact portions 3a, 3b, 3c with the loupe holder 9 in the loupe body 3 in the binocular loupes 100 of the present invention to be magnetized in desired magnetic properties (N-pole, S-pole) and strengths of magnetic force.

From the aforementioned viewpoint, in the loupe holder 9 and loupe body 3 in the binocular loupes 100 of the present invention, for example, it is also possible to make one of the holder 9 and body 3 the plastic magnet of the above-mentioned neodymium bonded materials, while making the other one of the holder 9 and body 3 general ferrite materials or ferrite-based plastic magnet materials.

Anisotropic magnetization of the plastic magnet is one of techniques for varying properties and directions of magnetic force, as methods of aligning anisotropic easy axes of magnetization, there are axial anisotropy, radial anisotropy, repulsion radial anisotropy, polar anisotropy and the like, and the magnet is produced by orientating the magnetic field in a desired direction, for example, such as a vertical axis direction and horizontal axis direction, by the magnetic field of a magnet of an injection molding apparatus and inside a die in molding.

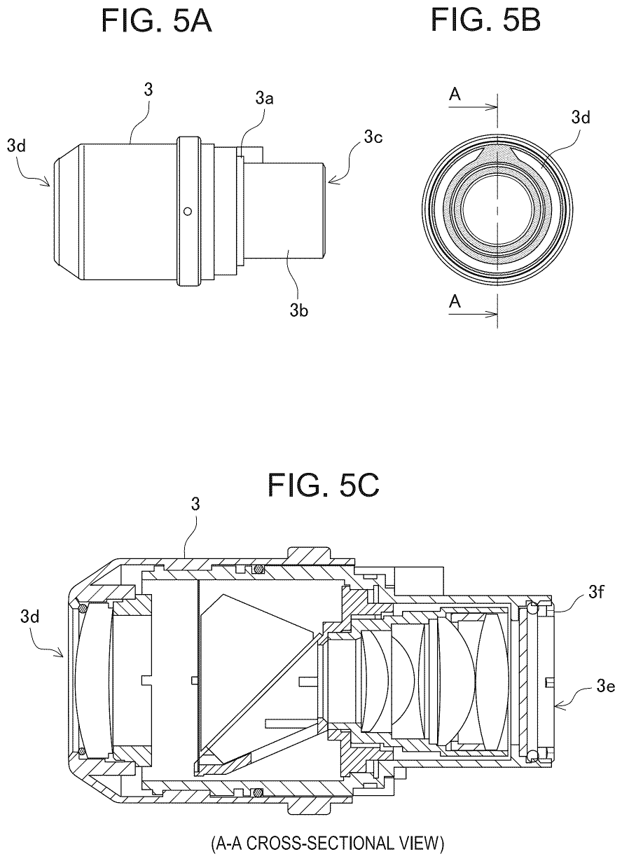

FIGS. 5A-5C show an example of the loupe body 3. FIG. 5A illustrates a side elevational view of the loupe body 3, FIG. 5B illustrates a front view viewed from the objective lens 3d side of the loupe body 3, and FIG. 5C illustrates a cross-sectional view.

As shown in FIG. 5C, the loupe body is comprised of a plurality of optical lenses and a plurality of mechanism parts along an optical axis line from the objective lens 3d to the ocular lens 3e inside the cylindrical body. Also with respect to loupes for enabling magnifications thereof to be varied by rotating the barrel on the objective lens side of the loupe body 3 shown in FIG. 4, optical lenses and internal mechanisms thereof are publicly known to a person skilled in the art, and therefore, descriptions of each of constituent parts thereof are omitted.

In addition, a plurality of beforehand prepared vision distance adjustment lenses 3f may be fitted into the eyepiece side end of the loupe body 3 attachably/detachably. In this case, the vision distance adjustment lens 3f is preferably supported by a thin rim of ferrite magnetic body surrounding the circumference of the lens.

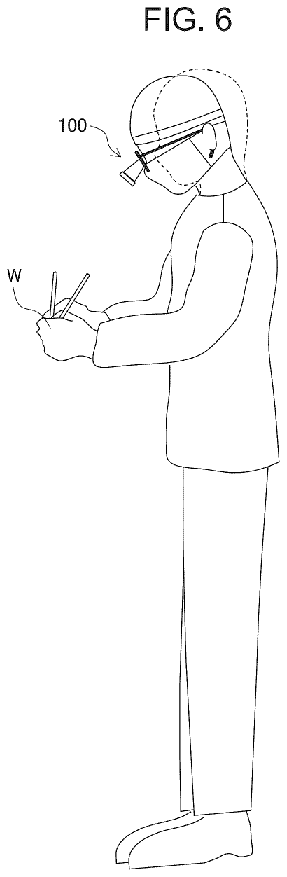

Next, based on FIGS. 6, 7 and 8, descriptions will be given to attachment of the loupe holder 9 to the surface of the carrier lens 4.

The loupe holder 9 is fitted into the opening pierced in the carrier lens 4, and is fixed at a predetermined angle with respect to the surface of the carrier lens 4, so that the loupe body 3 is directed toward a focus in an observation target direction. Specifically, attachment of the loupe holder 9 to the surface of the carrier lens 4 is determined by a downward insertion angle r and inward insertion angles p, q with reference to a plane of the carrier lens 4 of the loupe body 3 when the loupe body 3 is inserted into the loupe holder 9, and a distance PD between pupils of a user of the binocular loupes.

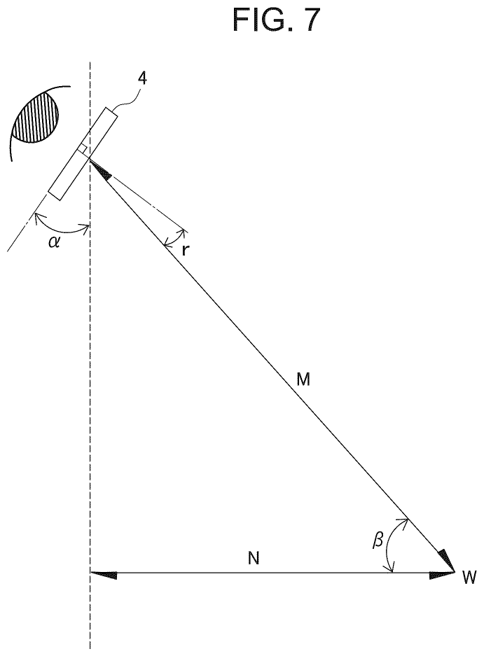

The binocular loupes 100 are used to enlarge an observation target in a work operation point W on hand to observe, in performing the work while leaning forward as shown in FIG. 6. At this point, the user concentrates lines of sight of both eyes on the observation target in a position of fingers through the right and left binocular loupes 3. Herein, using FIG. 7, the downward insertion angle will be described in this case. The downward insertion angle r is a downward attachment angle with respect to a perpendicular line from the surface of the carrier lens 4, in attaching the loupe body 3 to the carrier lens 4 through the loupe holder 9, and is capable of being obtained by an angle β determined by a distance M from the work operation point W to the carrier lens 4 and a horizonal direction distance N orthogonal to a vertical straight line passing through the center of the carrier lens 4, and a leaning angle α of the carrier lens 4 when the wearer performs an operation.

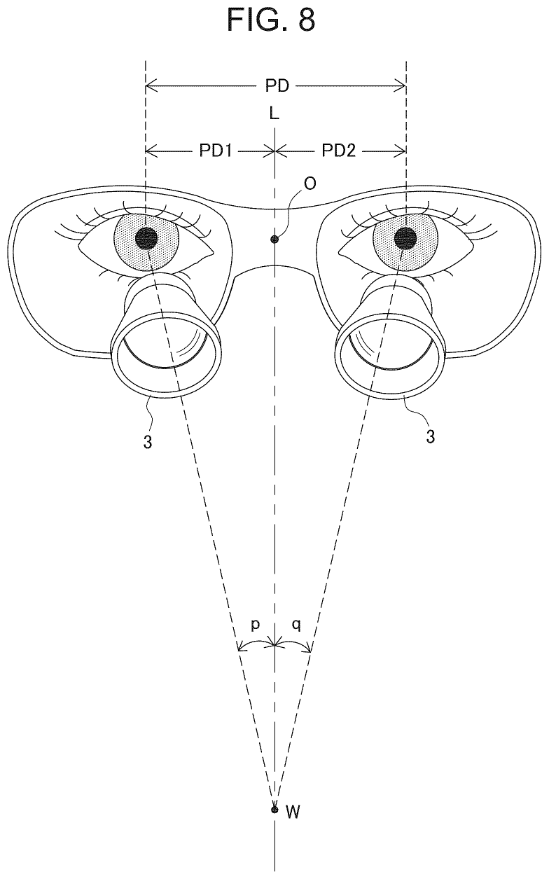

As shown in FIG. 8, the inward insertion angles p, q are angles when lines of sight with the front ends of the right and left loupe bodies 3 inserted into the loupe holders 9 directed toward the operation work point W intersect a line L for joining the center O of the glasses frame 10 and the work operation point W in the work operation point W. Then, the center O is an intersection point of a center line of the nose of the user and a line for connecting between right and left pupils, and the inward insertion angles p, q of the right and left loupe bodies 3 are respectively determined by distances PD1, PD2 from the center O to respective centers of pupils of the right-and-left both eyes, and a distance on the line L from the center O to the work operation point W.

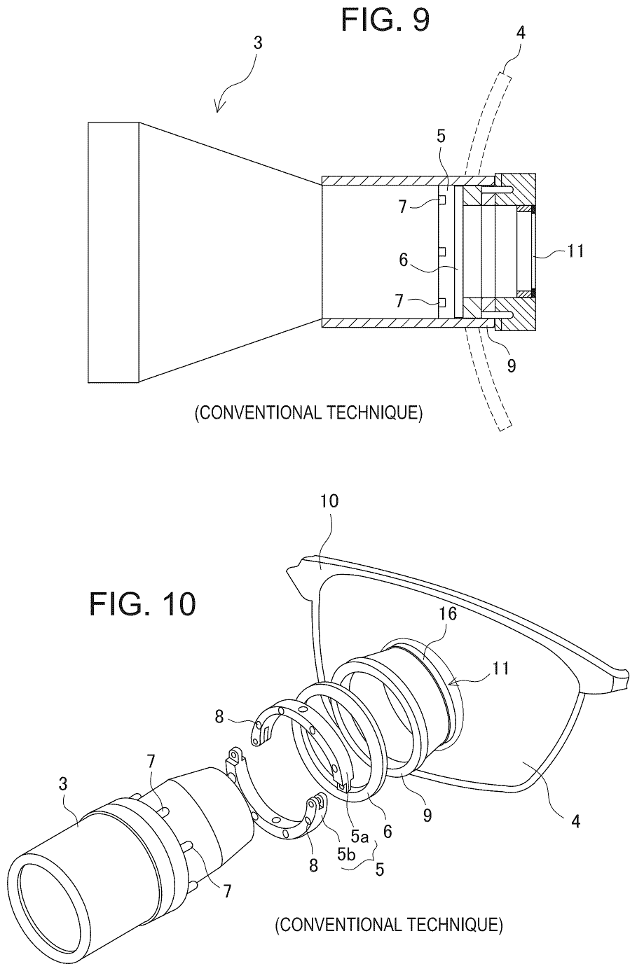

When the downward insertion angle r and inward insertion angles p, q of the loupe bodies 3 are determined, openings to insert the loupe holders 9 are provided in positions corresponding to pupils of both eyes in the right and left carrier lenses 4, the right loupe holder 9 is fixed and attached with an adhesive and the like so as to protrude from the surface of the carrier lens 4 at the downward insertion angler and inward insertion angle p, and the left loupe holder 9 is fixed and attached with an adhesive and the like so as to protrude from the surface of the carrier lens 4 at the downward insertion angle r and inward insertion angle q. Then, the binocular loupes 100 are used with the loupe body 3 attached to each of the first and second attachment portions of the loupe holder 9, and as necessary, the focus adjustment unit (corresponding to symbol 11 of FIGS. 9 and 10) attached.

As details are described above, the binocular loupes 100 according to the present invention are characterized in that the loupes are provided with a pair of right-and-left loupe bodies 3 with internal optical systems, the glasses frame 10 for holding the carrier lenses 4 to support the pair of loupe bodies 3 in visual directions toward an observation target, and the cylindrical loupe holders 9 attached to the carrier lenses 4 to receive the loupe bodies attachably/detachably with eyepiece side ends of the pair of loupe bodies 3 inserted, and that the loupe holders 9 and eyepiece side members of the pair of loupe bodies 3 are formed of the plastic magnet molded by mixing the magnetic powder into plastic materials.

Herein, the loupe body 3 is inserted into the loupe holder 9 via the protrusion-provided ring 12 with the protrusion portion 12a, the loupe holder 9 includes the engagement portion 9b of the hook-shaped groove for engaging in the protrusion portion 12a, and the loupe body 3 is formed not to be removed from the loupe holder 9.

Herein, the protrusion-provided ring 12 is formed of the plastic magnet molded by mixing the magnetic powder into plastic materials.

Further, the loupes are characterized in that at least each of the loupe holder 9 and the loupe body 3 is formed of the anisotropic magnetized material where crystal molecular arrangements of the magnetic powder are oriented in a certain direction, and that each of the loupe bodies 3 is inserted into the loupe holder 9 in a predetermined rotation direction.

Thus, in the binocular loupes according to the present invention, the loupe holder 9 and contact surfaces of the loupe body 3 contacting the loupe holder 9 are formed of the plastic magnet molded by mixing the magnetic powder into plastic materials, it is thereby possible to increase the diameter of the ocular lens at the eyepiece end of the loupe body 3, and thus, it is made possible to provide the binocular loupes of bright and clear high image quality, while widening the field of view of a practitioner.

### DESCRIPTION OF THE SYMBOLS

3 Loupe body
4 Carrier lens
9 Loupe holder
9b Engagement portion of the loupe holder
10 Glasses frame
12 Protrusion-provided ring
12a Protrusion portion
100 Binocular loupes

1. Binocular loupes for enlarging an observation target on hand to view, comprising:
a pair of right-and-left loupe bodies provided with internal optical systems;
a glasses frame adapted to hold carrier lenses for supporting the pair of loupe bodies in visual directions toward the observation target; and
cylindrical loupe holders attached to the carrier lenses to receive the loupe bodies attachably/detachably with the pair of loupe bodies inserted from eyepiece sides of the loupe bodies,
wherein the cylindrical loupe holders, and contact surfaces coming into intimate contact states with cylindrical inner surfaces of the loupe holders and eyepiece end side surfaces in the loupe bodies are formed of a plastic magnet molded by mixing magnetic powder into a plastic material, and
the loupe bodies come into intimate contact states with the cylindrical inner surfaces of the loupe holders to lock by magnetic attraction forces in the contact surfaces in the cylindrical inner surfaces and the eyepiece end side surfaces.

2. The binocular loupes according to claim 1, wherein the loupe bodies are inserted into the loupe holders further through protrusion-provided rings including protrusion portions,
the loupe holders include engagement portions of hook-shaped grooves to engage in the protrusion portions, and
the loupe bodies are formed not to be removed from the loupe holders.

3. The binocular loupes according to claim 2, wherein the protrusion-provided rings are formed of the plastic magnet molded by mixing the magnetic powder into the plastic material.

4. The binocular loupes according to claim 1 or 3, wherein at least each of the loupe holders and the loupe bodies is formed of an anisotropic magnetized material where a crystal molecular arrangement of the magnetic powder is oriented in a certain direction, and each of the loupe bodies is inserted into respective one of the loupe holders in a predetermined rotation direction.

5. The binocular loupes according to claim 3, wherein the protrusion-provided rings are formed of an anisotropic magnetized material where a crystal molecular arrangement of the magnetic powder is oriented in a certain direction, and more enhance forces for holding the loupe bodies in the loupe holders.

6. The binocular loupes according to any one of claims 1 to 5, wherein the loupe holders are fixed at predetermined angles with respect to surfaces of the loupe holders so that the loupe bodies inserted are directed toward the observation target.

7. The binocular loupes according to claim 6, wherein in the loupe bodies, a plurality of types of bodies is beforehand prepared where magnifications by the optical systems and/or vision adjustment distances differ from one another, and one is selected from among the bodies and is attached to respective one of the loupe holders, or one of the loupe bodies allowed to be selected and set within magnifications in a predetermined range and/or vision adjustment distances is selected and attached to respective one of the loupe holders.

8. The binocular loupes according to claim 6, wherein in the loupe bodies, a plurality of types of bodies is beforehand prepared where magnifications by the optical systems differ from one another, one is selected from among the bodies and is attached to respective one of the loupe holders, and
one of a plurality of beforehand prepared vision distance adjustment lenses is fitted into respective one of the eyepiece end side surfaces of the loupe bodies attachably/detachably.

9. The binocular loupes according to claim 8, wherein the vision distance adjustment lenses are held by rims surrounding circumferences of the lenses, and the rims are formed of a ferrite magnetic body.
